(19) United States
(12) Patent Application Publication
(10) Pub. No.: US 2004/0080353 A1
(43) Pub. Date: Apr. 29, 2004

(54) Circuit

(76) Inventors: Christofer Toumazou, Oxford (GB); Julius Georgiou, Nicosia (CY)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/466,793

(22) PCT Filed: Jan. 23, 2002
(86) PCT No.: PCT/GB02/00288

(30) Foreign Application Priority Data
Jan. 23, 2001 (GB) 0101759.9

(51) Int. Cl. G06G 7/24

(52) U.S. Cl. 327/350; 327/552

(57) ABSTRACT

A circuit implemented in a MOS device for operation with an internally non-linear topology, the circuit including at least first and second voltage ports, at least one voltage comparator for comparing the voltage at at least one of the voltage ports with a reference voltage, at least one of a current source or current sink for selectively sourcing current to or sinking current from the at least one of the voltage ports to maintain the voltage thereat in a voltage frame, thereby providing the circuit with a single stable dc operating point.

The present invention relates to a circuit, in one embodiment a filter circuit, implemented in a MOS device for operation with an internally non-linear topology, in particular a log-domain circuit for operation in the weak inversion region, and also to related methods.

Log-domain circuits implemented with MOS devices and biased in the weak inversion region are attractive alternatives to conventional linearised circuits for use in low power applications. One particular advantage of such circuits is the absence of an overhead associated with linearisation [1], thus allowing for the provision of a reduced supply voltage. Another advantage, arising from the current mode operation, is the superior high frequency performance.

It has been found, however, that such log-domain circuits implemented in MOS devices can have a plurality of stable dc operating points, leading to the possibility of self-biasing about unintended operating points, and thereby rendering the circuits useless in not providing the intended filtering [2].

The present invention aims to provide a circuit which is implemented in a MOS device for operation with an internally non-linear topology, in particular a log-domain circuit for operation in the weak inversion region, and includes a single stable dc operating point, and also aims to provide related methods.

Accordingly, the present invention provides a circuit implemented in a MOS device for operation with an internally non-linear topology, the circuit including at least first and second voltage ports, at least one voltage comparator for comparing the voltage at at least one of the voltage ports with a reference voltage, at least one of a current source or current sink for selectively sourcing current to or sinking current from the at least one of the voltage ports to maintain the voltage thereat in a voltage frame, thereby providing the circuit with a single stable dc operating point.

Preferably, the at least first and second voltage ports are provided by capacitors.

Preferably, the circuit includes at least one current source for sourcing current to the at least one of the voltage ports.

Preferably, the current source is a FET.

Preferably, the circuit includes a current sink for sinking current from the at least one of the voltage ports.

Preferably, the current sink is a FET.

The present invention also provides a method of maintaining a single stable dc operating point in a circuit implemented in a MOS device for operation with an internally non-linear topology, the method comprising the steps of: identifying the stable dc operating points in a circuit implemented in a MOS device and biased for operation with an internally non-linear topology, the circuit including at least first and second voltage ports; comparing the voltage at at least one of the voltage ports with a reference voltage; and one of sourcing current to or sinking current from the at least one of the voltage ports to maintain the voltage thereat in a voltage frame and thereby provide the circuit with a single stable dc operating point.

The present invention further provides a method of configuring a circuit implemented in a MOS device for operation with an internally non-linear topology, the method comprising the steps of: providing a circuit including at least first and second voltage ports as implemented in a MOS device and biased for operation with an internally non-linear topology; identifying the stable dc operating points of the circuit, one operating point being the desired operating point and the at least one other operating point being an undesired operating point; determining a reference voltage between that of the desired operating point and the at least one other operating point; and modifying the circuit to include state detection circuitry for comparing the voltage at the at least one of the voltage ports to the reference voltage, and one of sourcing current to or sinking current from the at least one of the voltage ports to maintain the voltage thereat in a voltage frame and thereby provide the circuit with a single stable dc operating point.

Preferably, the circuit is for operation with an externally linear topology.

Preferably, the circuit is a log-domain circuit operable in the weak inversion region.

Preferably, the circuit is a second- or higher-order circuit.

Preferably, the circuit is a filter circuit.

A preferred embodiment of the present invention will now be described hereinbelow by way of example only with reference to the accompanying drawings, in which:

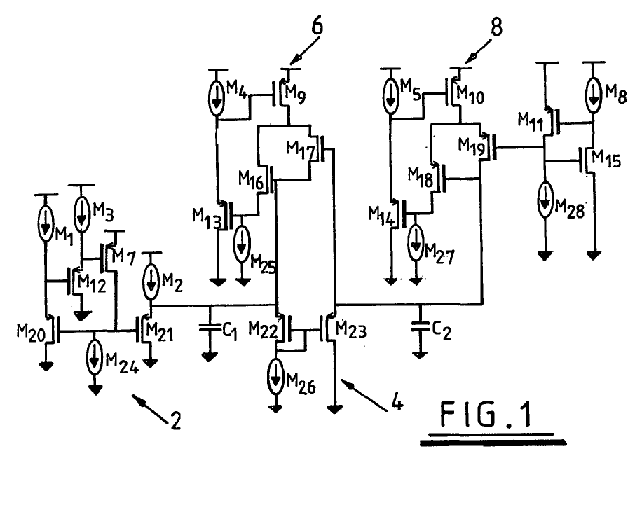

FIG. 1 illustrates a prior art log-domain filter circuit;

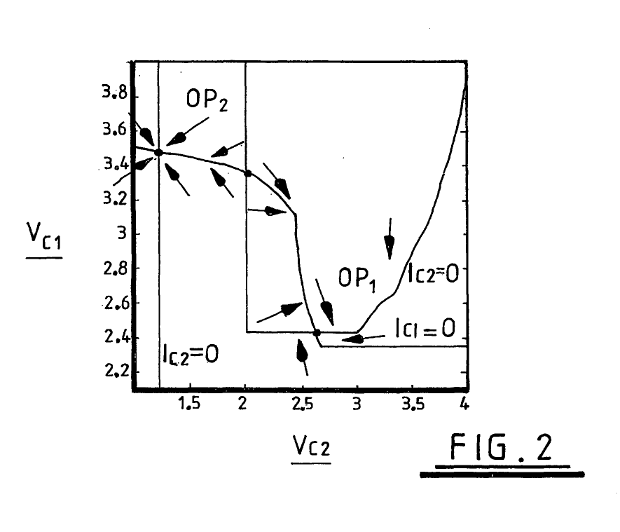

FIG. 2 illustrates the phase portrait of the filter circuit of FIG. 1;

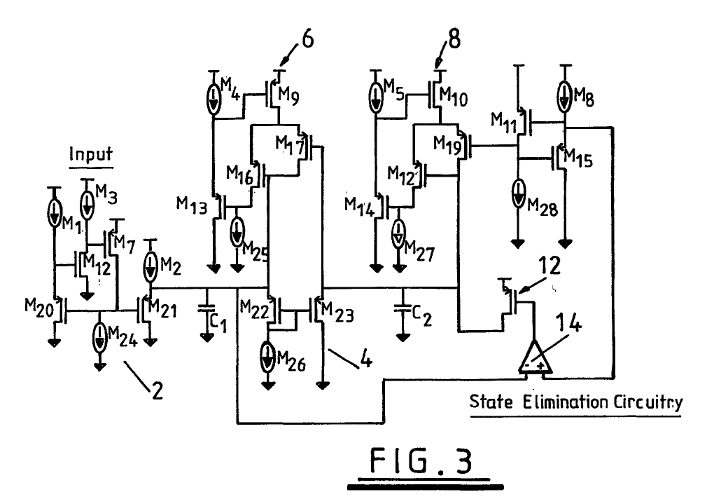

FIG. 3 illustrates a log-domain filter circuit in accordance with a preferred embodiment of the present invention; and

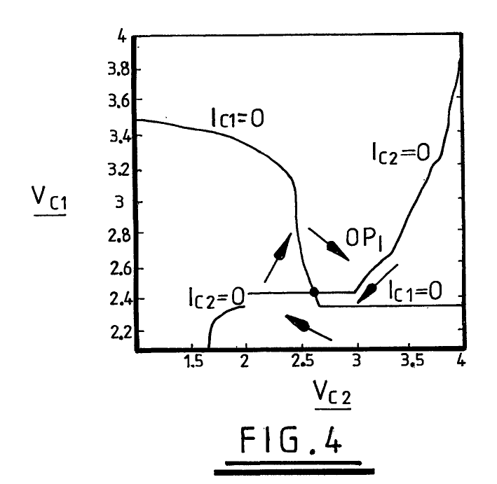

FIG. 4 illustrates the phase portrait of the filter circuit of FIG. 3.

FIG. 1 illustrates a prior art log-domain second-order filter circuit incorporating weak-inversion MOSFETs as designed by converting a bipolar junction transistor (BJT)-based log-domain filter [2].

The filter circuit includes first and second non-inverting E⁺ cells 2, 4 and first and second inverting E⁻ cells 6, 8. An input signal is introduced via M₃, in this embodiment implemented as a single PMOS transistor. An output signal, whether a low-pass or band-pass output signal, is obtained from a log-to-linear converter (not illustrated).

FIG. 2 illustrates the phase portrait of the filter circuit. The dc operating points OP₁, OP₂ are determined by replacing the capacitors C₁, C₂ with voltage sources and measuring the currents on sweeping every combination of voltages. The extrapolated zero-current contours for I_{C1}=0 and I_{C2}=0 can be measured by using the “contour” function in MATLAB (The MathWorks, Inc., 3 Apple Hill Drive, Natick, Mass. 01760-2098, United States of America). The dc operating points OP₁, OP₂ are where two current contours meet, since, when no current is sourced into the respective capacitor C₁, C₂, the voltage will remain at the same level. The direction of the space trajectories can be obtained using the “quiver” command, with the components being determined by I_{C1} and I_{C2}. As is clear from FIG. 2, the filter circuit of FIG. 1 includes two stable dc operating points OP₁, OP₂, one intended stable operating point OP₁ at V_{C1}=2.5 V and V_{C2}=2.5 V and the other unintended stable operating point OP₂ at V_{C1}=3.5 V and V_{C2}=12V.

FIG. 3 illustrates a log-domain second-order filter circuit incorporating weak-inversion MOSFETs in accordance with a preferred embodiment of the present invention.

The filter circuit is a modification of the above-described prior art log-domain filter circuit. In order to avoid unnecessary duplication of description, only the differences in the circuits will be described in detail, with like reference signs designating like parts.

The filter circuit differs from the above-described log-domain filter circuit in including state elimination circuitry. The state elimination circuitry comprises a MOSFET 12 for selectively sinking current into capacitor C₂ and a voltage comparator 14 which is configured to drive MOSFET 12 when voltage V_{C1} exceeds a predetermined threshold voltage, in this embodiment 3.2 V. In this embodiment, when voltage V_{C1} exceeds the threshold voltage 3.2 V, the MOSFET 12 is switched on to sink current into capacitor C₂. Current is sunk into the capacitor C₂ until voltage V_{C1} is below the threshold voltage 3.2 V.

FIG. 4 illustrates the phase portrait of the filter circuit. As will be noted, the filter circuit has only a single dc operating point OP₁. The filter circuit was tested for input signals of different magnitude and no instability was observed.

Finally, it will be understood that the present invention has been described in its preferred embodiment and can be modified in many different ways without departing from the scope of the invention as defined by the appended claims.

In one modification, the MOSFET 12 could be configured to act as a current source to cause a positive phase transition in the phase plane. As should be appreciated, the phase transition required is dependent on the relative positions of the dc operating points.

In addition, it should be understood that, although the present invention has been described in relation to a second-order circuit, the present invention is applicable to circuits of higher order, for example, third- and fourth-order circuits.

### REFERENCES

1. D. R. Frey “A 3.3 V electronically tunable active filter usable beyond 1 GHz”, Proc. ISCAS '94, 1994, vol. 5, pp 493-6

2. R. M. Fox and M. Nagarajan, “Multiple Operating Points in Log-Domain Filters”, Proc. ISCAS '99, 1999, vol. 2, pp 689-92

1. A circuit implemented in a MOS device for operation with an internally non-linear topology, the circuit including at least first and second voltage ports, at least one voltage comparator for comparing the voltage at at least one of the voltage ports with a reference voltage, at least one of a current source or current sink for selectively sourcing current to or sinking current from the at least one of the voltage ports to maintain the voltage thereat in a voltage frame, thereby providing the circuit with a single stable dc operating point.

2. The circuit of claim 1, wherein the at least first and second voltage ports are provided by capacitors.

3. The circuit of claim 1 or 2, wherein the circuit includes at least one current source for sourcing current to the at least one of the voltage ports.

4. The circuit of claim 3, wherein the current source is a FET.

5. The circuit of any of claims 1 or 4, wherein the circuit includes at least one current sink for sinking current from the at least one of the voltage ports.

6. The circuit of claim 5, wherein the current sink is a FET.

7. The circuit of any of claims 1 to 6, wherein the circuit is for operation with an externally linear topology.

8. The circuit of any of claims 1 to 7, wherein the circuit is a log-domain circuit operable in the weak inversion region.

9. The circuit of any of claims 1 to 8, wherein the circuit is a second- or higher-order circuit.

10. The circuit of any of claims 1 to 9, wherein the circuit is a filter circuit.

11. A method of maintaining a single stable dc operating point in a circuit implemented in a MOS device for operation with an internally non-linear topology, the method comprising the steps of:
identifying the stable dc operating points in a circuit implemented in a MOS device and biased for operation with an internally non-linear topology, the circuit including at least first and second voltage ports;
comparing the voltage at at least one of the voltage ports with a reference voltage; and
one of sourcing current to or sinking current from the at least one of the voltage ports to maintain the voltage thereat in a voltage frame and thereby provide the circuit with a single stable dc operating point.

12. The method of claim 11, wherein the circuit is biased for operation with an externally linear topology.

13. The method of claim 11 or 12, wherein the circuit is a log-domain circuit biased for operation in the weak inversion region.

14. The method of any of claims 11 to 13, wherein the circuit is a second- or higher-order circuit.

15. The method of any of claims 11 to 14, wherein the circuit is a filter circuit.

16. A method of configuring a circuit implemented in a MOS device for operation with an internally non-linear topology, the method comprising the steps of:
providing a circuit including at least first and second voltage ports as implemented in a MOS device and biased for operation with an internally non-linear topology;
identifying the stable dc operating points of the circuit, one operating point being the desired operating point and the at least one other operating point being an undesired operating point;
determining a reference voltage between that of the desired operating point and the at least one other operating point; and
modifying the circuit to include state detection circuitry for comparing the voltage at the at least one of the voltage ports to the reference voltage, and one of sourcing current to or sinking current from the at least one of the voltage ports to maintain the voltage thereat in a voltage frame and thereby provide the circuit with a single stable dc operating point.

17. The method of claim 16, wherein the circuit is biased for operation with an externally linear topology.

18. The method of claim 16 or 17, wherein the circuit is a log-domain circuit biased for operation in the weak inversion region.

19. The method of any of claims 16 to 18, wherein the circuit is a second- or higher-order circuit.

20. The method of any of claims 16 to 19, wherein the circuit is a filter circuit.

21. A circuit implemented in a MOS device for operation with an internally non-linear topology substantially as hereinbefore described with reference to FIGS. 3 and 4 of the accompanying drawings.

22. A method of maintaining a single stable dc operating point in a circuit implemented in a MOS device for operation with an internally non-linear topology substantially as hereinbefore described with reference to FIGS. 3 and 4 of the accompanying drawings.

23. A method of configuring a circuit implemented in a MOS device for operation with an internally non-linear topology substantially as hereinbefore described with reference to FIGS. 3 and 4 of the accompanying drawings.
